(19) United States
(12) Patent Application Publication
(10) Pub. No.: US 2014/0258048 A1
(43) Pub. Date: Sep. 11, 2014

(54) INFORMATION MATCHING SYSTEM

(71) Applicants: Ennio Bruno, Norristown, PA (US); Vito Cottone, Los Angeles, CA (US)

(72) Inventors: Ennio Bruno, Norristown, PA (US); Vito Cottone, Los Angeles, CA (US)

(21) Appl. No.: 13/791,918

(22) Filed: Mar. 9, 2013

(51) Int. Cl. G06Q 30/06

(52) U.S. Cl. CPC G06Q 30/0641; G06Q 30/0201
USPC 705/27.1; 705/26.8

(57) ABSTRACT

Systems, methods and computer readable media for information matching are disclosed. For example, leads (e.g., buyers or prospective franchisees) can be matched with companies (e.g., franchisors). Lead information forms can include user definable fields. The system can provide a lead preview based on fields selected by a user (e.g., a seller or a franchisor).

Embodiments relate generally to information matching systems and, more particularly, to systems, methods and computer-readable media for information matching/market making such as franchise lead generation, for example.

Some conventional lead generation systems may provide a lead to a seller (or client) participating in the lead generation service. Typically, the seller receiving the lead must accept the lead without seeing any details of the lead in advance. In these conventional lead generation systems, a seller receiving the leads may have to pay for buyer leads that are unsuitable in some respect for the seller's purposes. Further, some conventional lead generation systems may be limited in the ability for the seller to customize or select fields for information forms to be received from prospective buyer leads.

Embodiments were conceived in light of the above-mentioned problems and limitations, among other things.

Some implementations include a computer implemented method for generating leads. The method can include providing, using one or more computing devices, for display to a user (e.g., a seller, such as a franchisor), a first user interface adapted to receive a plurality of lead information fields, the lead information fields including a first group of predefined fields and an interface element for adding one or more user definable fields. The method can also include receiving, at the one or more computing devices, input from the user indicating one or more user definable fields and criteria for screening buyers (e.g. prospective franchisees). The method can further include causing, using the one or more computing devices, to be displayed a second user interface adapted to permit the user to select one or more lead information fields for preview when a prospective lead is provided to the user for preview.

The method can include receiving, at the one or more computing devices, input from the user indicating a group of lead information fields selected for preview by the user. The method can also include providing, using the one or more computing devices, for display to a buyer, a third user interface adapted to permit the buyer to enter information into the lead information fields. The method can further include determining, at the one or more computing devices, whether the information provided by the buyer (e.g., prospective franchisee) meets criteria of the user (e.g., a franchisor).

For example, when the information provided by the prospective franchisee meets the criteria of the prospective franchisor, a lead preview can be provided to the prospective franchisor, the lead preview can include fields from the information entered by the prospective franchisee according to the lead information fields selected for preview by the user.

The method can also include permitting the user to accept or reject (or ignore) a lead based on the preview, and, when the lead is accepted, providing full information entered by the buyer to the user. The method can also include providing a field for collecting information about the reasons a lead is not accepted when that lead is not accepted by the user. The method can further include charging an account associated with the user when a lead preview is accepted. In addition, or as an alternative, a user may be charged a periodic fee (e.g., a monthly or annual fee) regardless of the number of leads provided or accepted by the user.

Information entered by the buyer can be verified through manual techniques, automatic techniques or a combination of the above.

The system can receive an indication that the buyer has entered into a purchase agreement with the user and an incentive payment can be made to the buyer. The incentive payment can include a portion of a payment paid by the user and/or a lead generation provider.

Some implementations can include a computer system adapted to implement the method described above.

Some implementations can include a nontransitory computer readable medium bearing software instructions adapted to cause a processor to perform the method described above.

### BRIEF DESCRIPTION OF THE DRAWINGS

FIG. 1 shows a diagram of an example franchise lead matching system in accordance with at least one embodiment.

FIG. 2 shows an example lead form in accordance with at least one embodiment.

FIG. 3 shows an example lead preview field selection form in accordance with at least one embodiment.

FIG. 4 is a flow chart of an example method for franchisor information entry in accordance with at least one embodiment.

FIG. 5 is a flow chart of an example method for prospective franchisee or lead information gathering in accordance with at least one embodiment.

### DETAILED DESCRIPTION

In general, an embodiment can include a system, method or computer readable media for information matching, which can include matching leads (e.g., prospective franchisees) with companies (e.g., franchisors), sellers with buyers, members of a first group with members of a second group, or the like. While the embodiments described herein are discussed in terms of franchisor/franchisee lead matching, it will be appreciated that the lead generation systems methods and computer readable media described herein can be applied to other areas of lead generation and information matching. It will also be appreciated that while the descriptions are of a seller receiving matching buyer leads, the methods and systems can be applied to provide matching seller leads to a buyer and in such an implementation, an information form and associated fields would be directed to a prospective seller to provide information to a buyer.

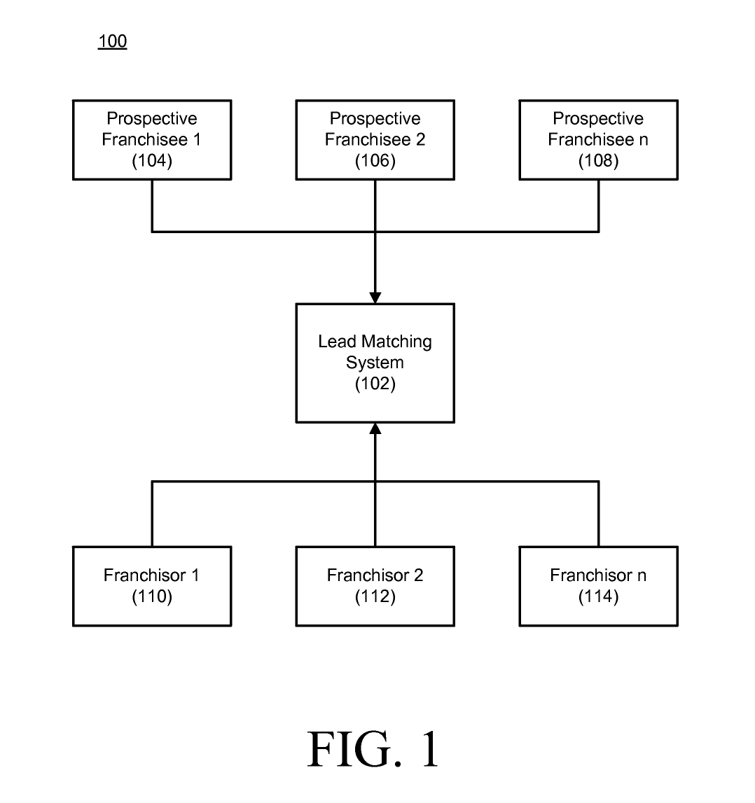

As shown in FIG. 1, an information (e.g., lead) matching system 100 includes a lead matching processor 102, a plurality of leads or prospective franchisees (104-108) and a plurality of franchisors (110-114).

In operation, leads or prospective franchisees view franchise opportunities presented by the lead matching system. The franchise opportunities in the lead matching system have been entered by the franchisors (110-114). When a prospective franchisee (e.g., 104) views a franchise opportunity of interest, the prospective franchisee can complete a lead form to provide information to the selected franchisor. This lead information is then transmitted at least partially to the franchisor and the franchisor can contact the prospective franchisee if the lead is accepted by the franchisor.

In this way, prospective franchisees entering lead information are only entering lead information for those franchise opportunities that are of interest or that may be of interest. Also, franchisors are given the opportunity to preview leads and select only those leads of interest to the franchisor. The previewing of leads is accomplished by presenting to the franchisor only a subset of the lead information collected in the lead form. For example, the subset of information may include name, past experience in an industry, net worth, available liquid assets, and the like. What may be omitted from the lead preview may be the contact information for the prospective franchisee, for example. When the franchisor accepts the lead the full lead information may become available including, for example, the contact information for the lead or prospective franchisee.

An information matching system can be implemented in part using a content management system (CMS) (e.g., Wordpress, Joomla or the like). In a CMS implementation, the system can provide a seller with numerous functions and/or features that permit the seller to manage the information matching service. For example, the CMS system can provide a user interface that permits a seller to review snapshot profile lead information prior to “acceptance” of the lead, or alternatively to “ignore” (or reject) the profile lead. The CMS system can also provide an interface showing a log of all accepted or ignored leads and which permits the seller to review the leads in any categories (e.g., accepted, ignored, denied, or the like).

Also, the system can provide an ability to retrieve “ignored” leads for reconsideration and potential acceptance as a prospective new franchisee. When a lead is to be ignored (or denied), the seller can provide the prospective new franchisee (e.g., the buyer) with a custom explanation as to why he/she was not qualified.

For the lead information forms, the system can provide an ability for a seller to set any form field found on the lead form as “required” or “optional”. Also, the system permits additional custom entry fields that may be more specific to the offering for inclusion as part of the lead information (or application) form. Such custom fields may be set as “required” or “optional” for lead form fields.

Further, the system can be configured to permit a seller to target prospective leads according to one or more criteria. For example, the system can include a geo target marketing tool function in which the Seller may geographically target specific areas (e.g., one or more countries, regions, states, counties, cities, neighborhoods or the like for brand development of brand offering) and limit leads being accepted for evaluation to the one or more areas.

The system can provide real time brand offering profile tracking via a profile “analytics” tool that presents analytics data of the brand offering. The system can also provide one or more of the stored data records and/or fields as a report (e.g., for display and/or printing). The system can also permit a seller to edit and update profile information which can include uploading capabilities for content including, but not limited to images (e.g., pictures), videos, press, social media posts and the like.

The system can provide a seller with an ability to set lead filter types (for example to filter leads by state, capital required). The system can also permit a seller to add primary sales person contact info such as: first and last name, phone number, email, and/or picture for auto send to lead upon lead acceptance.

The system can also include a built-in directory of service providers and resources listed for buyer and/or seller's convenience relevant to the industry or specific business of interest. The directory can be built into company site, available only to prospective buyers and/or sellers whom have opted into company site.

In addition to seller functions and features, the CMS implementation can provide functions and features for buyers (e.g., prospective new franchisees). For example, the system can provide application status tracking (e.g., “accepted,” “ignored,” “pending”). The system can also provide a capability for profile editing and updating, which can include uploading capabilities for images (e.g. pictures), videos, press, social media posts and/or the like.

The system can provide a cash back redemption tool via a “redeem” button or other similar user interface element. Activating the redeem button can initiate a cash back redemption process. All or a part of the cash back payment can be made payable in the form of a donation to a charity of the buyer's choice. The system can include cash back redemption status tracking. The tracking can be performed by configuring the CMS system to interface with an external package delivery service (e.g., FedEx, UPS, USPS or the like) in order to automatically obtain delivery status on items such as contracts, cash back payments and the like. The delivery status and tracking information can be obtained automatically and reported to the buyer and/or seller automatically.

The system can also include a built-in directory of service providers and resources relevant to the industry or specific business of interest and which are listed for buyer and/or seller convenience. The directory can be built into the CMS system, and may be made available only to prospective buyers and/or sellers who have opted into the CMS system.

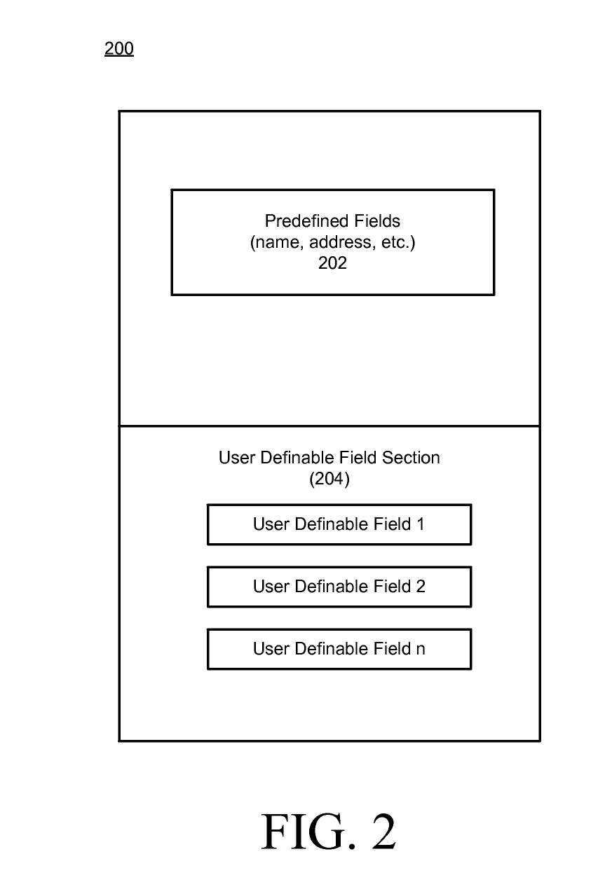

An example lead form is shown in FIG. 2. The lead form 200 includes a section of predefined fields 202 and an optional section of user defined fields 204.

The predefined fields 202 may include standard biographic or demographic data such as, for example name, address, phone number, email address, net worth, educational background, business background, business experience, interests, hobbies, and the like.

The user definable fields in section 204 can include information fields that may be specific to a particular franchisor's business. For example, a food industry franchisor may want to know whether a prospective franchisee has had experience in the food industry and, if so, how many years and in what type of food business.

By including predefined fields and user defined fields on the lead form, franchisors are given the ability to quickly use a form that has the standard predefined fields and optionally add user defined fields, if desired. The user definable fields can allow a franchisor to have a more accurate picture of whether a prospective franchisee is a suitable candidate for the franchise opportunity.

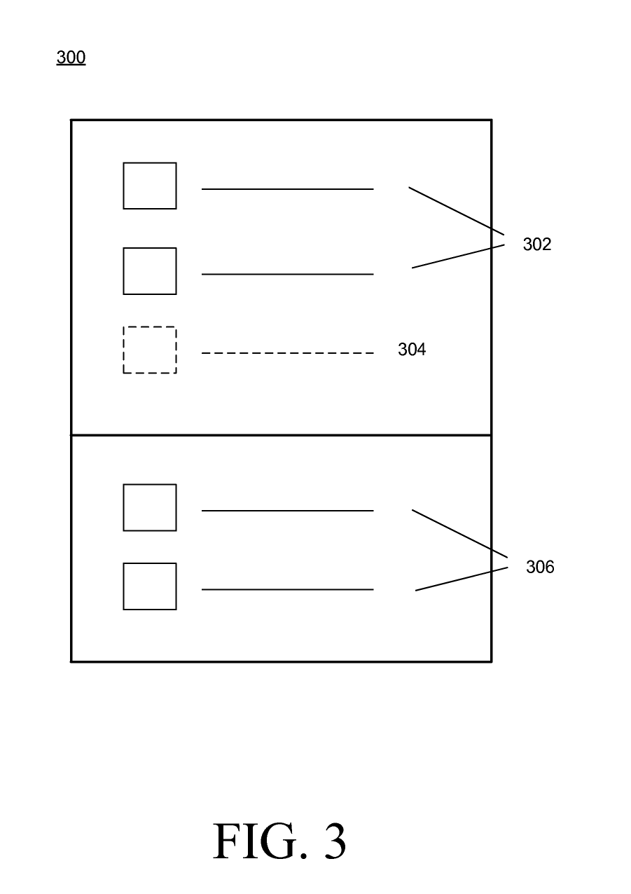

Once a franchisor has set up a lead form for the franchise opportunity, the franchisor can set up a lead preview section for previewing leads provided by the system. FIG. 3 shows an example form for lead preview field section 300. In the form 300, there are fields in the predefined section 302 that are selectable and there are fields that are not selectable 304. All of the fields in the user definable selection may be selectable 306 or only a portion of the user definable fields may be selectable. The form may include required fields and a portion of these fields may be visible (e.g., name, city, state or the like) in a preview and a portion may not be visible in a preview (e.g., contact information). The determination of whether a field is selectable for lead preview can be made by the administrator of the lead matching system.

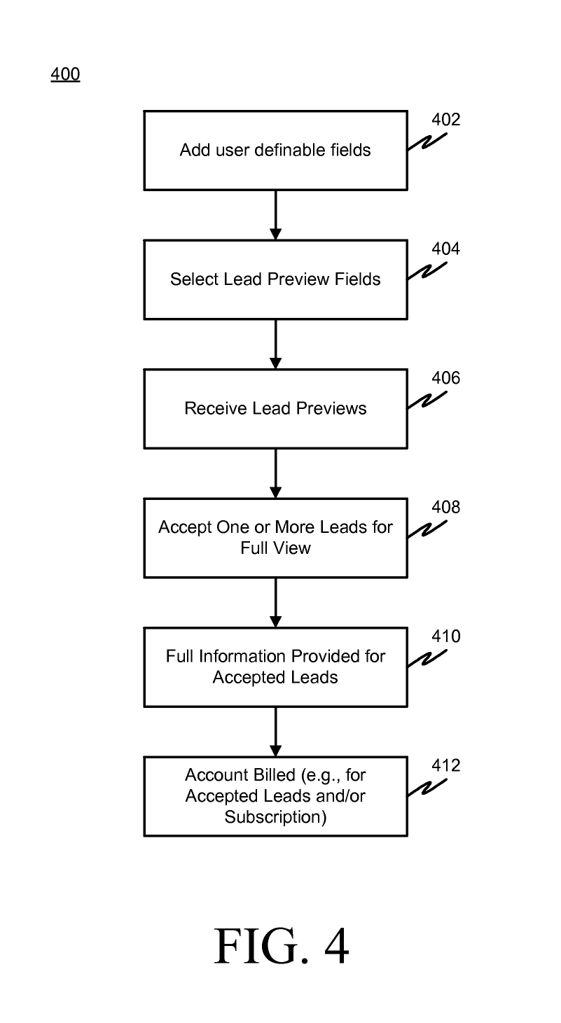

FIG. 4 is an example flow chart of the process for a franchisor using the franchise lead matching system as discussed above. Processing begins at 402 where a profile is created for a franchisor and the franchisor can add user defined fields (optionally) to the lead form (e.g., 200 shown in FIG. 2). The franchisor profile can be created manually, automatically or through a combination of the above. For example, the system can automatically pre-populate a franchisor's profile with publicly available information, e.g., ticker information, stock price, franchise data, and the like, or may link to third party sources of similar information. Processing continues to 404.

At 404, the franchisor selects lead preview fields as discussed above. Processing continues to 406.

At 406, a franchisor receives lead previews from the lead matching system. Prior to providing lead previews, the lead matching system may verify lead information using techniques that are manual, automatic or both. For example, the lead matching system may verify email addresses and phone numbers by contacting the lead through the provided email address or phone number and requesting that the lead provide confirmation information (e.g., a code number). Once the lead information has been verified, a subset of the information may be provided to a franchisor as a lead preview. The franchisor can then view the lead previews that are presented in accordance with the lead preview field selections that have been previously made and also in conjunction with the lead form itself having predefined fields and user definable fields as discussed above in relation to FIG. 2. Processing continues to 408.

At 408, the franchisor can select one or more of the leads for a full view via “Accept” as pre-defined by the franchisor. Once selected (or accepted) for full view, all of the fields of the lead form (including predefined fields and user defined fields) become visible to the franchisor (410). The franchisor may then further evaluate the leads and may contact the leads (e.g., through the lead generation system and/or directly via the verified contact information provided by the system) if they look to be suitable candidates for the franchise opportunity, for example. Processing continues to 412.

At 412, the franchisor account is billed or charged for the number of full view leads that have been selected. It will be appreciated that other billing models (e.g., monthly subscription, annual subscription, or the like) may be used as an alternative to or in conjunction with the pay per lead model.

It will be appreciated that 402 through 412 can be repeated in whole or in part in order to accomplish a contemplated franchisor lead matching task.

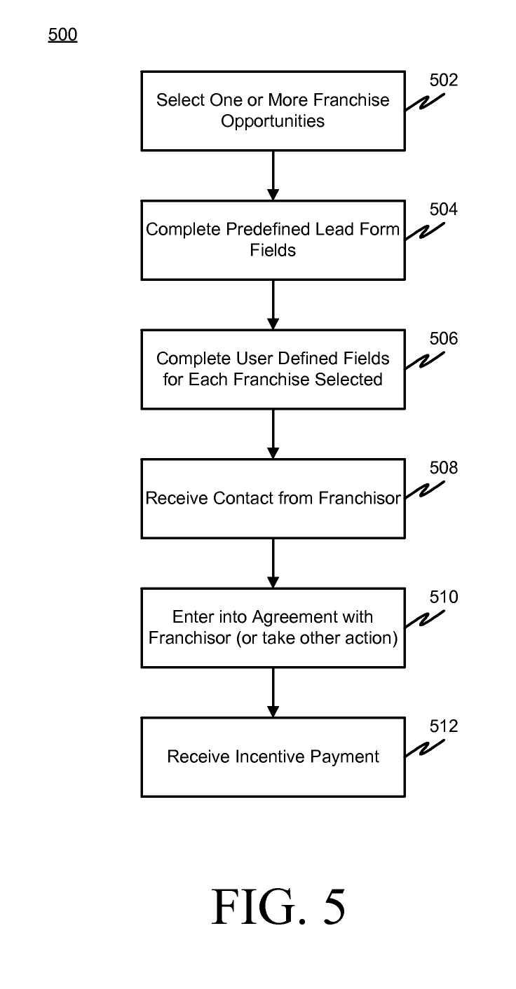

FIG. 5 shows a flow chart of an example method for franchisee or prospective franchisee franchise opportunity selection. Processing begins at 502

At 502, a prospective franchisee selects one or more franchise opportunities. Processing continues to 504.

At 504, a prospective franchisee completes the predefined lead form fields of the lead form. These fields being the predefined fields are applicable to all franchise opportunities selected by the prospective franchisee. Accordingly, the prospective franchisee may enter the data for the predefined lead form fields once (e.g., first and last name, email address, phone number, mailing address, age, gender and/or the like). Processing continues to 506.

At 506, a prospective franchisee completes user defined fields, if any, for each of the selected franchise opportunities. If each of the selected franchise opportunities has user defined fields, then the prospective franchisee will complete those fields for each of the selected franchise opportunities. The system may indicate to the prospective franchisee that the user defined fields being entered are associated with a particular one of the selected franchise opportunities. Processing continues to 508.

At 508, the prospective franchisee may be contacted by one or more of the franchisors for which the prospective franchisee submitted information (e.g., through the lead generation system and/or directly via the verified contact information provided by the system). The contact may be by email, postal mail, telephone or the like. Processing continues to 510

At 510, the prospective franchisee may enter into a franchise agreement with one or more of the franchisors contacted via the franchise lead matching system or take other action such as requesting more information, attending a meeting, or the like. Entering into a franchise agreement may constitute a contractual agreement between the franchisee and the franchisor. Processing continues to 512.

At 512, the prospective franchisee (now possibly a franchisor of one or more of the franchise opportunities) receives an incentive payment from the franchisor and/or the lead matching service. The incentive payment may be paid to the lead matching service and a portion of that payment shared with the franchisee or the incentive payment may be paid directly from the franchisor to the franchisee, or and yet another alternative, the lead matching service may pay incentive out of money not received from the franchisor.

It will be appreciated that 502 to 512 can be repeated in whole or in part in order to accomplish a franchisee/franchisor matching task.

It will be appreciated that the modules, processes, systems, and sections described above can be implemented in hardware, hardware programmed by software, software instructions stored on a nontransitory computer readable medium or a combination of the above. A system for lead generation can be implemented, for example, using a processor configured to execute a sequence of programmed instructions stored on a nontransitory computer readable medium to provide the lead matching service as a website. In general, a system for lead generation can be implemented, for example, using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like, or a scripting language such as javascript, php or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer readable media may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the user interface, web and/or computer programming arts.

Moreover, embodiments of the disclosed method, system, and computer readable media can be implemented in software executed on a programmed general purpose computer, a special purpose computer, a microprocessor, or the like.

It is, therefore, apparent that there is provided, in accordance with the various embodiments disclosed herein, systems, methods and computer readable media for lead generation.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

1. A computer implemented method for information matching, the method comprising:
providing, using one or more computing devices, for display to a prospective information purchaser, a first user interface adapted to receive a plurality of lead information fields, the lead information fields including a first group of predefined fields and an interface element for adding one or more fields defined by the prospective information purchaser;
receiving, at the one or more computing devices, input from the prospective information purchaser indicating one or more fields defined by the prospective information purchaser and criteria, defined by the prospective information purchaser, for qualifying prospective customers of an offering by the prospective information purchaser;
causing, using the one or more computing devices, to be displayed a second user interface adapted to permit the prospective information purchaser to select one or more lead information fields for preview when a prospective customer lead is provided to the prospective information purchaser for preview;
receiving, at the one or more computing devices, input from the prospective information purchaser indicating a group of lead information fields selected by the prospective information purchaser for displaying when a prospective customer lead is provided to the prospective information purchaser for preview;
providing, using the one or more computing devices, for display to a prospective customer, a third user interface adapted to permit the prospective customer to enter information into the lead information fields;
determining, at the one or more computing devices, whether the information provided by the prospective customer meets the criteria defined by the prospective information purchaser; and
when the information provided by the prospective customer meets the criteria defined by the prospective information purchaser, providing a lead preview to the prospective information purchaser, the lead preview including fields from the information entered by the prospective customer according to the lead information fields selected for preview by the prospective information purchaser.

2. The method of claim 1, further comprising:
permitting the prospective information purchaser to perform an action including one of accepting, ignoring or rejecting a lead based on the preview;
when the lead is accepted, providing full information entered by the prospective customer to the prospective information purchaser.

3. The method of claim 2, further comprising:
charging an account associated with the prospective information purchaser based on one or more of a number of lead previews accepted and a periodic subscription.

4. The method of claim 1, further comprising:
verifying the information entered by the prospective customer.

5. The method of claim 2, further comprising:
receiving, at the one or more computing devices, an indication that the prospective customer has entered into a purchase agreement with the prospective information purchaser; and
providing an incentive payment to the prospective customer.

6. The method of claim 5, wherein the incentive payment includes a portion of a payment paid by the prospective information purchaser.

7. The method of claim 5, wherein the incentive payment includes a portion of a payment paid by an information matching service.

8. A computer system for information matching, the system comprising:
a hardware processor; and
a nontransitory computer readable data storage device coupled to the hardware processor, the data storage device having software instructions stored therein that, when executed by the hardware processor, cause the hardware processor to perform a series of operations including:
providing, for display to a prospective information purchaser, a first user interface adapted to receive a plurality of lead information fields, the lead information fields including a first group of predefined fields and an interface element for adding one or more fields defined by the prospective information purchaser;
receiving input from the prospective information purchaser indicating one or more fields defined by the prospective information purchaser and criteria, defined by the prospective information purchaser, for screening prospective customers of an offering by the prospective information purchaser;
causing to be displayed a second user interface adapted to permit the prospective information purchaser to select one or more lead information fields for preview when a prospective customer lead is provided to the prospective information purchaser for preview;
receiving input from the prospective information purchaser indicating a group of lead information fields selected by the prospective information purchaser for displaying when a prospective customer lead is provided to the prospective information purchaser for preview;
providing for display to a prospective customer, a third user interface adapted to permit the prospective customer to enter information into the lead information fields;
determining whether the information provided by the prospective customer meets criteria defined by the prospective information purchaser; and
when the information provided by the prospective customer meets the criteria defined by the prospective information purchaser, providing a lead preview to the prospective information purchaser, the lead preview including fields from the information entered by the prospective customer according to the lead information fields selected for preview by the prospective information purchaser.

9. The system of claim 8, wherein the operations further comprise:
permitting the prospective information purchaser to perform an action including one of accepting, ignoring, or rejecting a lead based on the preview;
when the lead is accepted, providing full information entered by the prospective customer to the prospective information purchaser.

10. The system of claim 9, wherein the operations further comprise:
charging an account associated with the prospective information purchaser based on one or more of a number of lead previews accepted and a periodic subscription.

11. The system of claim 8, wherein the operations further comprise:
verifying the information entered by the prospective customer.

12. The system of claim 9, wherein the operations further comprise:
receiving, at the one or more computing devices, an indication that the prospective customer has entered into a purchase agreement with the prospective information purchaser; and
providing an incentive payment to the prospective customer.

13. The system of claim 12, wherein the incentive payment includes a portion of a payment paid by the prospective information purchaser.

14. The system of claim 12, wherein the incentive payment includes a portion of a payment paid by an information matching provider.

15. A nontransitory computer readable medium having stored thereon software instructions that, when executed by a processor, cause the processor to perform a series of operations including:
providing, for display to a prospective information purchaser, a first user interface adapted to receive a plurality of lead information fields, the lead information fields including a first group of predefined fields and an interface element for adding one or more fields defined by the prospective information purchaser;
receiving input from the prospective information purchaser indicating one or more fields defined by the prospective information purchaser and criteria, defined by the prospective information purchaser, for screening prospective customers of an offering by the prospective information purchaser;
causing a second user interface to be displayed, the second user interface adapted to permit the prospective information purchaser to select one or more lead information fields for preview when a prospective customer lead is provided to the prospective information purchaser for preview;
receiving input from the prospective information purchaser indicating a group of lead information fields selected by the prospective information purchaser for displaying when a prospective customer lead is provided to the prospective information purchaser for preview;
providing for display to a prospective customer, a third user interface adapted to permit the prospective customer to enter information into the lead information fields;
determining whether the information provided by the prospective customer meets criteria defined by the prospective information purchaser; and
when the information provided by the prospective customer meets the criteria defined by the prospective information purchaser, providing a lead preview to the prospective information purchaser, the lead preview including fields from the information entered by the prospective customer according to the lead information fields selected for preview by the prospective information purchaser.

16. The nontransitory computer readable medium of claim 15, wherein the operations further comprise:
permitting the prospective information purchaser to accept or reject a lead based on the preview; and
when the lead is accepted, providing full information entered by the prospective customer to the prospective information purchaser.

17. The nontransitory computer readable medium of claim 16, wherein the operations further comprise:
charging an account associated with the perspective information purchaser when a lead preview is accepted.

18. The nontransitory computer readable medium of claim 15, wherein the operations further comprise:
verifying the information entered by the prospective customer.

19. The nontransitory computer readable medium of claim 15, wherein the operations further comprise:
receiving, at the one or more computing devices, an indication that the prospective customer has completed a predetermined action; and
providing an incentive payment to the prospective customer.

20. The nontransitory computer readable medium of claim 19, wherein the incentive payment includes a portion of a payment paid by the prospective information purchaser.
